(19) United States
(12) Patent Application Publication
(10) Pub. No.: US 2008/0075604 A1
(43) Pub. Date: Mar. 27, 2008

(54) Process For The Electrolytic Treatment Of A Component, And A Component With Through-Hole

(76) Inventors: Rene Jabado, Berlin (DE); Uwe Kaden, Himmelpfort (DE); Ursus Kruger, Berlin (DE); Daniel Kortvelyessy, Berlin (DE); Ralph Reiche, Berlin (DE); Michael Rindler, Schoneiche (DE); Jan Steinbach, Berlin (DE); Peter Tiemann, Witten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/667,330

(22) PCT Filed: Sep. 19, 2005
(86) PCT No.: PCT/EP05/54647

§ 371 Date: Nov. 1, 2007

(30) Foreign Application Priority Data
Nov. 9, 2004 (EP) 04026620.7

(51) Int. Cl. C25D 5/02; B01J 19/08; F01D 5/14

(52) U.S. Cl. 416/241 R; 205/118; 205/131; 205/687

(57) ABSTRACT

Electrolytic methods are used to treat large external surfaces. There is described a method for internally coating through-holes of a wall, wherein an electrolyte flows through the through-hole during the treatment and deposits material on the respective inner surface. A single electrode is being used for at least two through-holes.

### CROSS REFERENCE TO RELATED APPLICATIONS

This application is the US National Stage of International Application No. PCT/EP2005/054647, filed Sep. 19, 2005 and claims the benefit thereof. The International Application claims the benefits of European application No. 04026620.7 EP filed Nov. 9, 2004, both of the applications are incorporated by reference herein in their entirety.

### FIELD OF INVENTION

The invention relates to a process for the internal coating of at least two through-holes of a component in accordance with the preamble of claim 1 and to a component in accordance with the preamble of claim 15.

### BACKGROUND OF INVENTION

Through-holes in components sometimes have to be reworked on account of not having the desired geometry. This may be the case in a newly produced component if the diameter is too large, in which case material has to be applied inside the through-hole.

The situation may also arise whereby the through-hole has become oxidized or corroded during operation of the component, in which case the oxidation or corrosion products have to be removed, which changes the geometry, i.e. increases the cross section or diameter of the through-hole. For the component to be reused, it is refurbished, during which the desired geometry has to be restored (EP 1 160 352 A1).

DE 198 32 767 A1 describes a process for cleaning a component, in which the cleaning liquid flows through the through-holes.

DE 34 03 402 discloses the electrochemical treatment of a workpiece on the external surface, wherein the electrolyte attacks the surface.

U.S. Pat. No. 5,865,977 describes a method for determining the flow of an electrolyte through a channel.

CH 397 900, DE 44 28 207 A1, U.S. Pat. No. 6,234,752 B1, U.S. Pat. No. 6,303,193 B1 and US 2003/0173213 A1 disclose processes for the electrolytic treatment of a workpiece.

The processes either do not describe coating processes or describe only the treatment of external surfaces.

### SUMMARY OF INVENTION

Therefore, it is an object of the invention to provide a process which allows the internal coating of at least two through-holes.

The object is achieved by the process as claimed in an independent claim.

A further object of the invention is to provide a component which can be used despite the geometry of a through-hole deviating from a desired geometry.

The object is achieved by the component as claimed in a further independent claim.

Further advantageous measures are listed in the subclaims. These measures can advantageously be combined with one another in any appropriate way.

According to a process for the electrolytic treatment of a component, which has at least two through-holes, at least two through-holes are in each case treated, in particular coated, on their inner surface. A single pole electrode, having an identical polarity, is used for at least two, more or all of the through-holes, in that the pole electrode has a projection for each through-hole that is to be treated. The projection in particular projects into the respective through-hole. A component having at least two through-holes is produced by the process.

### BRIEF DESCRIPTION OF THE DRAWINGS

In the drawing:

FIGS. 1-5, 13 show apparatuses for carrying out the process according to the invention,

FIGS. 6, 7 show substeps of the process according to the invention,

FIG. 8 shows a schematic curve of the change in a flow quantity over time,

FIG. 9 shows a turbine blade or vane,

FIGS. 10, 11 show a combustion chamber, and

FIG. 12 shows a turbine.

### DETAILED DESCRIPTION OF INVENTION

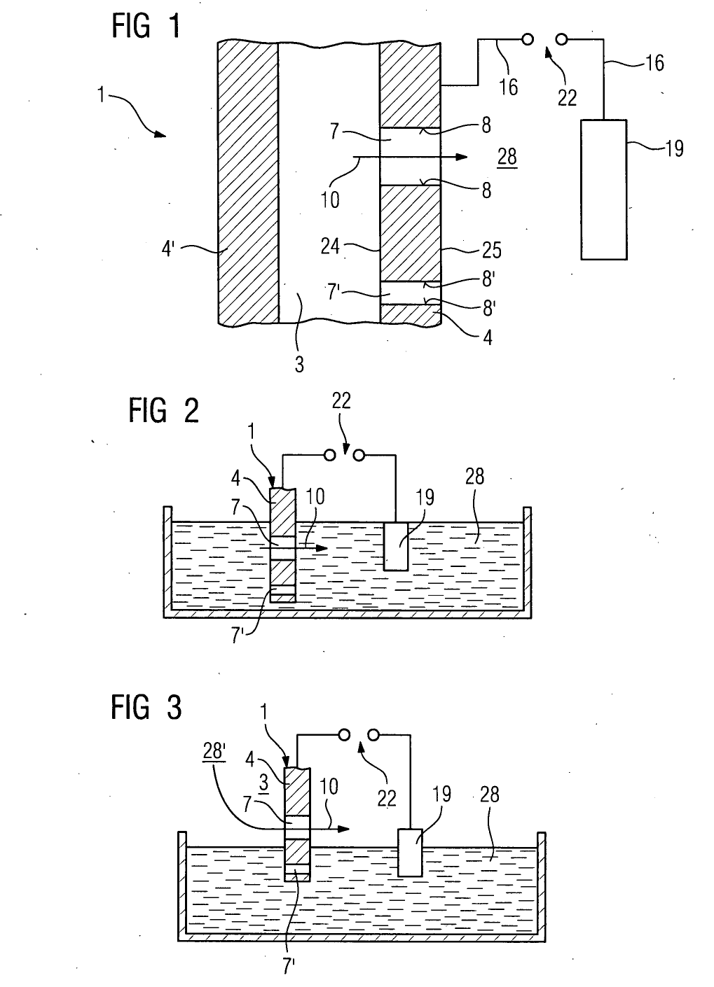

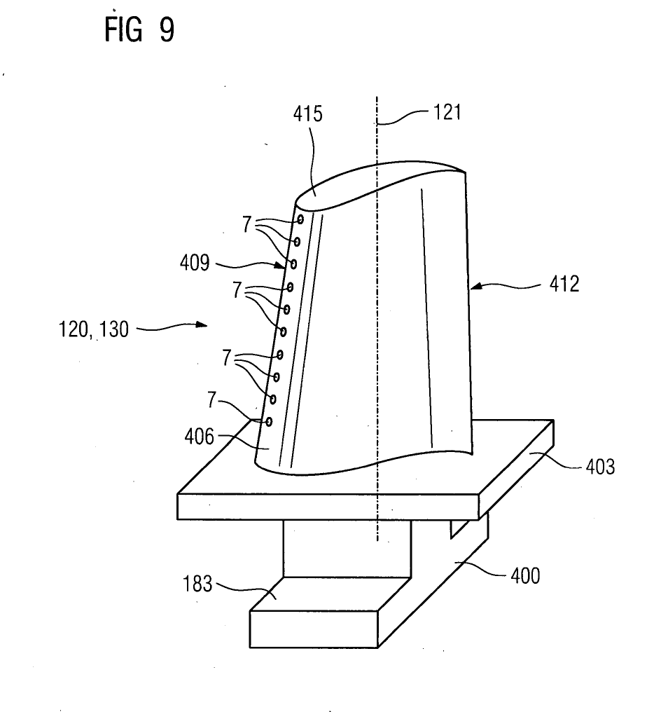

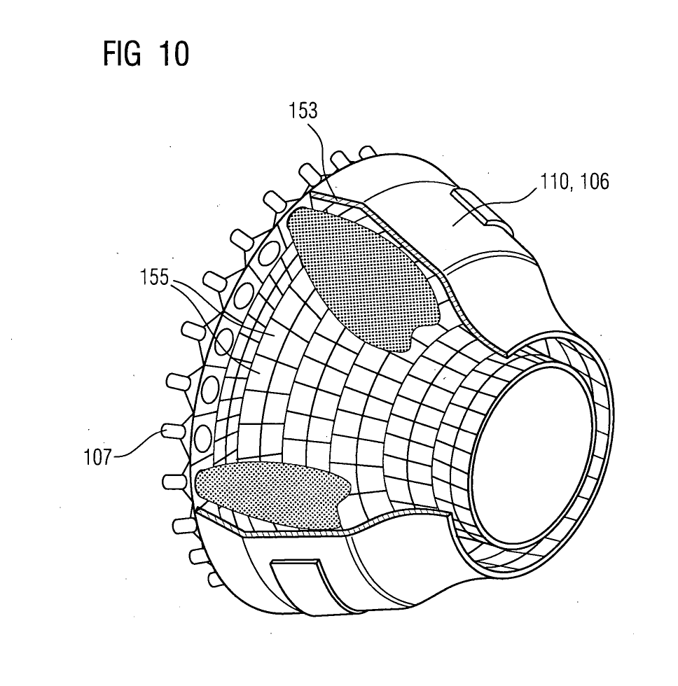

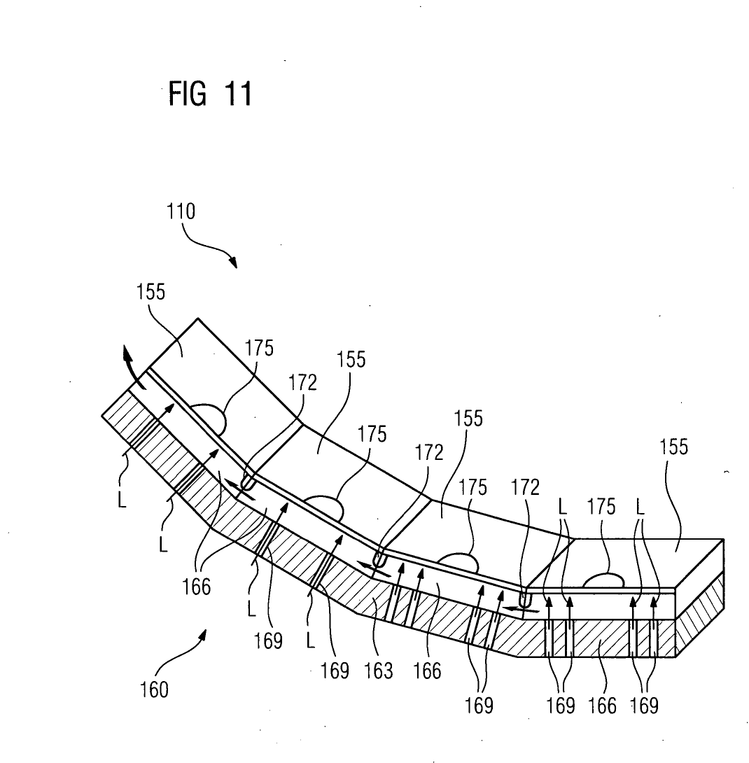

FIG. 1 shows a component 1, which includes for example a cavity 3, at least one external wall 4, 4′ with at least two through-holes 7, 7′ in at least one external wall 4, 4′ as well as an internal surface 24 and an external surface 25. The component 1 may for example be a hollow component 1 (e.g. turbine blade or vane 120, 130, FIG. 9) or a panel-like component 1 (e.g. heat shield element 155, FIGS. 10, 11).

The through-holes 7, 7′ have a cross section which is, for example, round and needs to be treated, for example because it is too large for use and therefore needs to be narrowed. Other geometries can also be treated using the process according to the invention.

The through-holes 7, 7′ are narrowed by electrolytically coating the through-holes 7, 7′ on their respective inner surfaces 8, 8′. In particular, an electrolyte 28 flows through the through-holes 7, 7′, for example in the arrow direction 10 (for example from the inside outward, i.e. out of the cavity 3), in order for material to be applied electrolytically to the inner surfaces 8, 8′ of the through-holes 7, 7′.

The progress of the internal coating of the at least two through-holes 7, 7′ over the course of time is monitored for example by the through-flow (volume or mass per unit time) of the electrolyte 28 through one, two or more through-holes 7, 7′ being determined. The progress of the internal coating can be monitored continuously (for example online) or discontinuously. On account of the fact that material is applied to the inner sides 8, 8′ of the through-holes 7, 7′ during the internal coating, the cross section of the through-holes 7, 7′ narrows and the through-flow quantity V of the electrolyte 28 per unit time t decreases.

Calibration operations carried out beforehand are used to ascertain when the desired geometry of the through-hole(s) 7, 7′ has been reached.

Any process for determining the quantity of a medium which flows through a through-hole 7, 7′ can be used to determine the progress of the internal coating. In particular the various principles of pressure difference (Bernoulli pressure tube, through-flow measurement using the active pressure method, or Venturi tube with diaphragm), the suspended-matter flow measurement method, the inductive flow measurement method or the ultrasound flow meter can be used for quantitative flow measurements.

As material is applied within the through-hole 7, 7′, the composition or concentration of the electrolyte 28 flowing through (e.g. the concentration of the coating material) changes, and this is recorded for example capacitively or inductively or by other forms of concentration measurement.

By way of example, the flow through the through-hole 7 can be determined by determining the drop in current during the electrolysis, by means of calibration curves.

For the electrolysis, the component 1 constitutes, for example, a pole counterelectrode and is connected to a current/voltage source 22 with a pole electrode 19 via electrical supply conductors 16.

In the case of a coating process, the component 1 is a cathode (pole counterelectrode) and the pole electrode 19 is an anode. In the case of a coating-removal process, the component 1 is an anode (pole counterelectrode), and the pole electrode 19 is a cathode. Therefore, component 1 and pole electrodes 19 have opposite polarities.

Component 1 and pole electrode 19 are arranged, for example, together in an electrolyte 28 (FIG. 2), so as to close an electric circuit.

The electrolyte 28 can then flow through the through-holes 7, 7′, for example at the instigation of a propeller drive (not shown). The through-holes 7, 7′ are arranged in the electrolyte 28.

In the case of a hollow component 1, the electrolyte 28 is for example pumped into the cavity 3, in the case of a turbine blade or vane 120, 130 for example downward through the blade or vane root 183, so that the electrolyte 28 emerges again through the through-holes 7. In this case, the through-holes 7, 7′ may be arranged in (FIG. 2) or outside (FIG. 3) the electrolyte 28.

The through-hole 7, 7′ need not necessarily but may be present in the same electrolyte bath 28 as the component 1 and the pole electrode 19. The electrolyte 28′ for the internal coating of the through-hole(s) 7, 7′ may also be supplied separately (FIG. 3), for example through the cavity 3 or from the outside through the through-holes 7. In the case of the separate supply (e.g. through a pipeline), it is possible, for example, to use a different electrolyte 28′ than the electrolyte 28 in which the pole electrode 19 and the component 1 are arranged. The electrolytes 28, 28′ may, for example, be different in terms of their composition and/or concentration. The through-hole(s) 7, 7′ may be arranged outside the electrolyte 28 (FIG. 3) or in the electrolyte 28 (not shown).

By way of example, one or more metallic elements (Al, Pt, Cr) or alloys (MCrAlX) or ceramic materials (Al₂O₃) can be used as material for the internal coating. In particular, the pole electrode 19 is made from metal and/or carbon.

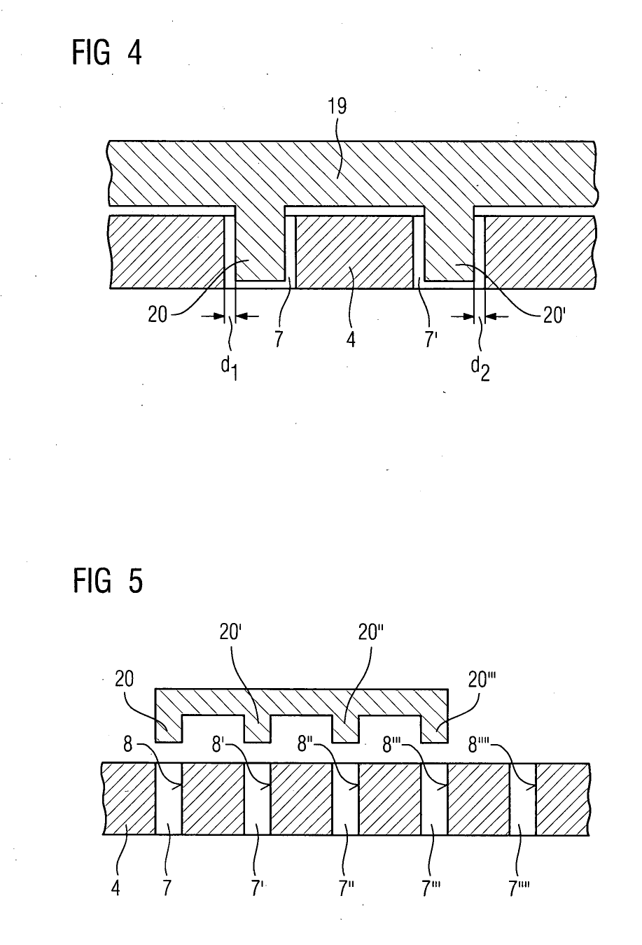

FIG. 4 shows a pole electrode 19 with projections 20, 20′, which by way of example project into the for example two through-holes 7, 7′, so that the same voltage is present.

In the case of a coating-removal process, the distance d₁, d₂ between the projections 20, 20′ and the wall 4 in the through-holes 7, 7′ increases. When this distance d₁, d₂ becomes too great, the process stops automatically, since the potential becomes too low. If the distances d₁, d₂ of the through-holes 7, 7′ differ, the process stops individually at different times in each through-hole 7, 7′.

In the case of a coating process too, a single pole electrode 19 is used for the at least two through-holes 7, 7′, but in this case in the event of different distances d₁, d₂ the coating process does not stop automatically, since here the distance is decreasing. Consequently, to terminate the process, either the applied voltage has to be interrupted or the electrolyte has to be removed or at least one of the electrodes has to be isolated from the electrolyte. The electrode 19 is for example of locally differing design, for example by having different shapes of projections 20, 20′.

FIG. 5 illustrates a plurality of through-holes 7, 7′, 7″, 7′″, 7″″ with one pole electrode 19. In FIG. 5, the wall 4 of the component 1 has a plurality of through-holes 7, 7′, 7″, 7′″, 7″″. It is possible for all of the through-holes 7, 7′, 7″, 7′″, 7″″ or just some of the through-holes 7, 7′, 7″, 7′″ to be treated.

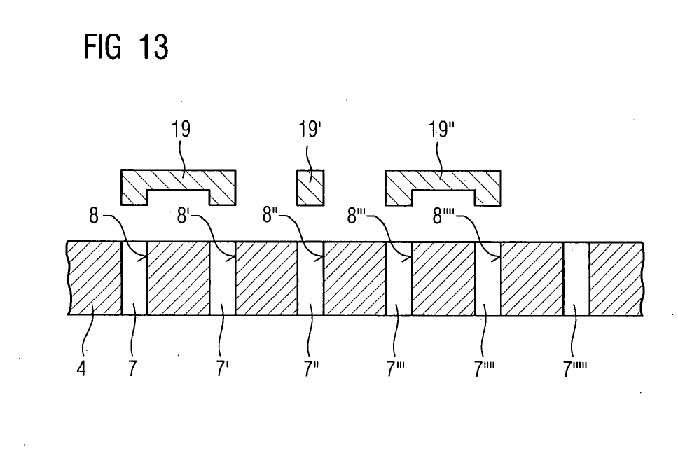

The through-holes 7, 7′, 7″, 7′″, 7″″ that are to be treated are assigned a single pole electrode 19. If appropriate, the remaining through-holes 7″″, . . . can be treated using a single electrode in a second, separate electrolytic treatment step. It is also possible for a plurality of through-holes (7, 7′), (7′″, 7″″) in each case to be combined in groups, in which case each group can in each case be assigned a single pole electrode 19, 19″ (FIG. 13), in which case the pole electrodes 19, 19′, 19″ can be used simultaneously for the electrolytic treatment.

If appropriate, it is even possible to additionally use an individual pole electrode 19′ for a through-hole 7″, while at the same time a single pole electrode 19 is being used for at least two or more through-holes 7, 7′, 7″, 7′″.

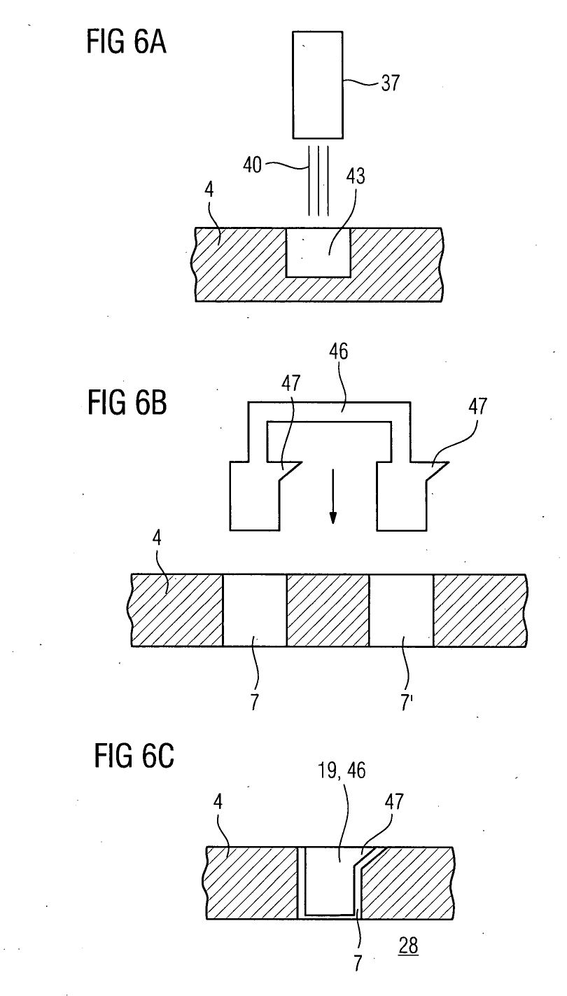

FIG. 6 shows a further variant of the process according to the invention. In this case, in a first step the through-holes 7, 7′ can be produced for example by means of a laser 37 and its laser beams 40 (FIG. 6a shows a blind hole 43 as a precursor of the through-hole 7).

In a further process step or a process step which replaces the process step of FIG. 6a in order to produce the through-hole 7, an EDM electrode 46 is used in a spark erosion process, in which case the EDM electrode 46 has the contour, in particular with a shape (diffuser 47) that is more complex than a cylindrical shape, of the through-holes 7, 7′ according to a mold core for example in a casting process (FIG. 6b). This EMD electrode 46 can in turn be used as pole electrode 19 in the subsequent electrolytic coating process (FIG. 6c).

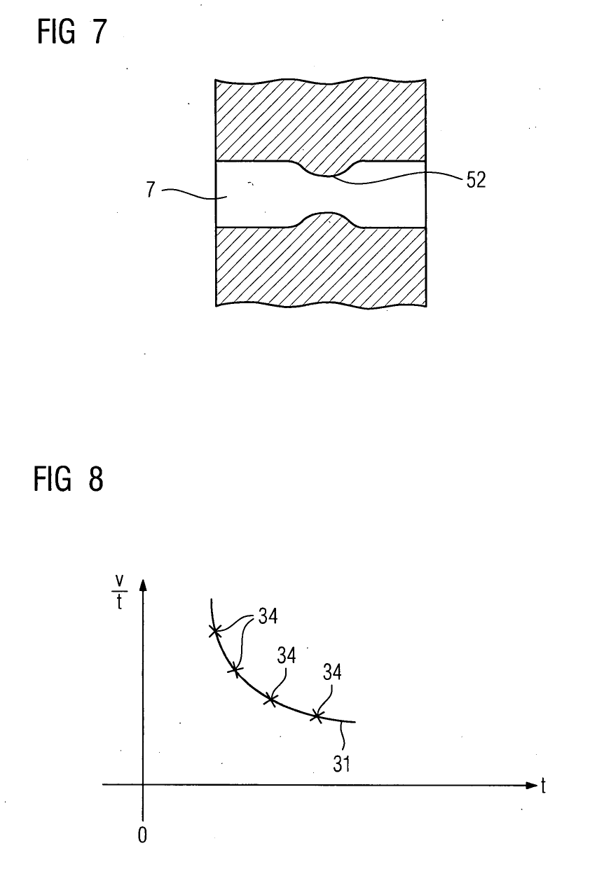

FIG. 7 shows a through-channel 7 which has projections 52 that locally narrow the through-flow. However, this is undesirable.

As a result of high voltage pulses being applied, in particular the local projections 52 can be removed during the coating-removal process, since it is here that the distance between the pole electrode 19 and the projection 52 is particularly small. This results in a uniform profile of the cross section of the through-hole 7, which has not yet been coated or had the coating removed.

If appropriate, masks can be used for the surfaces 24, 25, so that only the through-hole 7, 7′ is coated. It is optionally possible for only the inner surfaces 8 and the internal surface 24 of the component 1 to be coated. In this case, by way of example, aluminum is used for internal aluminizing. In addition, the external surface 25 of the component 1 could also be coated, for example if the external surface 25 is likewise to be aluminized. Furthermore, it is possible for only the inner surfaces 8 of the through-holes and the external surface 25 of the component to be coated, for example if an MCrAlX layer is required on the outer surface 25.

FIG. 8 shows, by way of example, a schematic curve of the change in the quantitative flow through a through-hole 7 over the course of time during a coating process.

When, during the internal coating of the through-hole 7, material is applied to the inner surfaces 8 of the through-hole 7, the cross section of the through-hole 7 narrows and the quantitative flow V/t decreases with time, as illustrated by the curve 31 represented by the solid line. The curve 31 can be determined continuously or discontinuously by measuring individual values 34. In both cases, the measurement can be monitored on line, i.e. the values are transmitted to a computer, which stops the process when the predetermined value for the quantitative flow, which corresponds to a desired geometry of the through-holes 7, is reached. The curve 31 is only schematic and may also have a different profile (for example linear).

FIG. 9 shows a perspective view of a blade or vane 120, 130 as an example of a component 1 with a through-hole 7 which is treated in accordance with the invention.

The blade or vane 120 may be a rotor blade 120 or a guide vane 130 of a turbomachine, which extends along a longitudinal axis 121. The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406. As a guide vane 130, the vane may have a further platform (not shown) at its vane tip 415.

A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials are used in all regions 400, 403, 406 of the blade or vane 120, 130. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 is hollow in form. If the blade or vane 120, 130 is to be cooled, it also has film-cooling holes (through-hole 7) which can be subsequently treated by means of the process according to the invention. To protect against corrosion, the blade or vane 120, 130 has, for example, suitable, generally metallic, coatings, and to protect against heat it generally also has a ceramic coating.

FIG. 10 shows a combustion chamber 110 of a gas turbine 100. The combustion chamber 110 is configured, for example, as what is known as an annular combustion chamber, in which a multiplicity of burners 102 arranged circumferentially around the turbine shaft 103 open out into a common combustion chamber space. For this purpose, the combustion chamber 110 overall is of annular configuration positioned around the turbine shaft 103.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155. On the working medium side, each heat shield element 155 is equipped with a particularly heat-resistant protective layer or is made from material that is able to withstand high temperatures. A cooling system is also provided for the heat shield elements 155 and/or their holding elements, on account of the high temperatures in the interior of the combustion chamber 110.

A heat shield element 155 as an example of a component 1 (through-hole 7) has, for example, holes (not shown) through which a fuel or fuel/gas mixture flows and which can be subsequently treated by means of the process according to the invention.

The materials used for the combustion chamber wall and its coatings may be similar to those used for the turbine blades or vanes.

FIG. 11 illustrates a heat shield arrangement 160, in which heat shield elements 155 are arranged next to one another, covering the surface, on a support structure 163. Usually, a plurality of rows of heat shield elements 155 are arranged adjacent to one another on the support structure 163, for example in order to line a relatively large hot gas space, such as for example a combustion chamber 110. The heat shield arrangement 160 can for example line the combustion chamber 110 and/or a transition region between combustion chamber 110 and turbine blade or vane 112 of a gas turbine 100, in order to prevent damage to the support structure 163 while the gas turbine 100 is operating.

To reduce the thermal stresses, there is provision, for example, for the heat shield elements 155 in each case to be cooled by means of cooling air on their surface facing away from the combustion chamber 110.

At least two adjacent heat shield elements 155a, 155b form a cooling-air channel 166 between the support structure 163 and in each case that surface of the heat shield elements 155a, 155b which faces away from the hot gas 113. In this way, the two said neighboring heat shield elements 155a, 155b communicate for example via the cooling air stream L which flows directly from one of the neighbors to the other in the common cooling-air channel 166 formed by the neighbors.

FIG. 11 illustrates, as an example, four heat shield elements 155, which form a common cooling-air channel 166. However, a significantly greater number of heat shield elements, which may also be arranged in a plurality of rows, are also suitable.

The cooling air L which is fed into the cooling-air channel 166 through openings 169 cools the heat shield elements 155 on the rear side, for example by means of impingement cooling, wherein the cooling air L impinges virtually perpendicularly on that surface of the heat shield elements 155 which is remote from the hot gas, and can thereby absorb and dissipate thermal energy. The cooling of the heat shield elements 155 can also be realized by convection cooling, in which case cooling air L passes substantially parallel to the surface of the heat shield elements 155 on the rear side thereof and can thereby likewise absorb and dissipate thermal energy.

In FIG. 11, the cooling air L as cooling air stream moves largely from right to left in the common cooling-air channel 166 formed by the heat shield elements 155 and can be fed to a burner 107, which is located for example in the combustion chamber 110, in order to be used for the combustion.

To prevent the cooling air L from the cooling-air channel 166 from passing directly into the combustion chamber 110 and to prevent hot gas from the combustion chamber 110 from entering the cooling-air channel 166, by way of example sealing elements 172 are provided between the heat shield elements 155.

FIG. 11 also illustrates, for example, a screw-connection apparatus 175, for example a recess for receiving a bolt. To anchor the heat shield elements 155 to the support structure 163, it is advantageous for a securing element, for example a bolt, to be introduced into the screw-connection apparatus 175 and to be secured on the side of the support structure 103, for example by means of a nut.

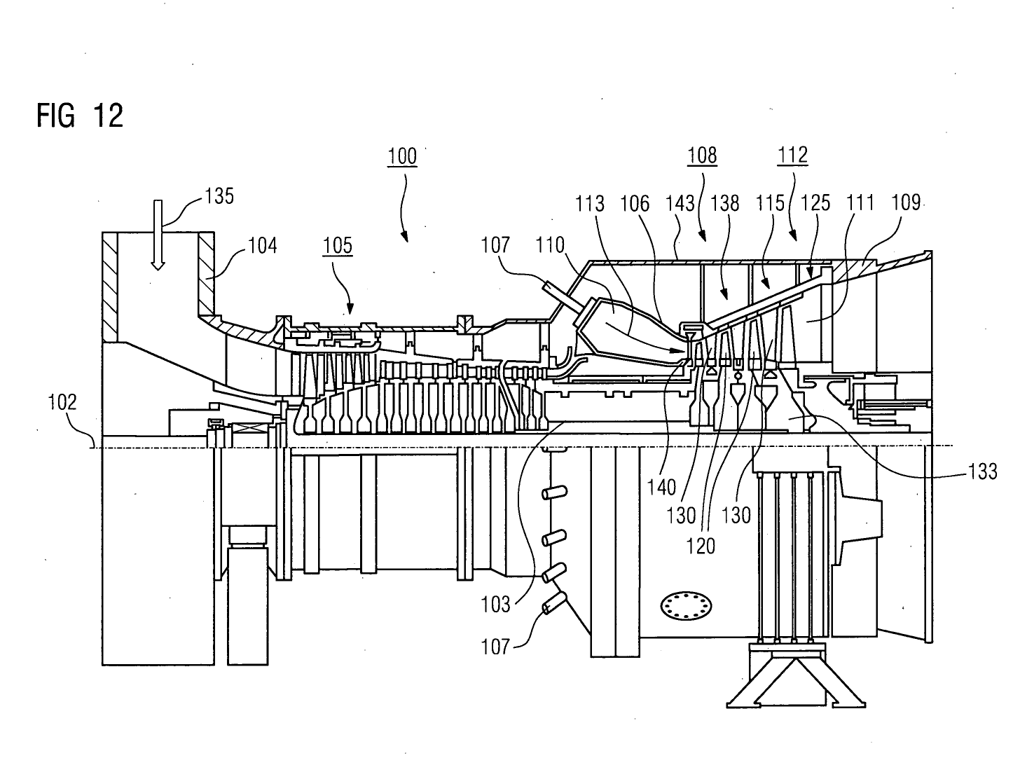

FIG. 12 shows, by way of example, a partial longitudinal section through a gas turbine 100. In the interior, the gas turbine 100 has a rotor 103 which is mounted such that it can rotate about an axis of rotation 102 and is also referred to as the turbine rotor. An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103. The annular combustion chamber 106 is in communication with a, for example, annular hot-gas passage 111, where, by way of example, four successive turbine stages 112 form the turbine 108. Each turbine stage 112 is formed, for example, from two blade or vane rings. As seen in the direction of flow of a working medium 113, in the hot-gas passage 111a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses. To be able to withstand the temperatures which prevail there, they have to be cooled by means of a coolant. Substrates of the components may likewise have a directional structure, i.e. they are in single-crystal form (SX structure) or have only longitudinally oriented grains (DS structure). By way of example, iron-base, nickel-base or cobalt-base superalloys are used as material for the components, in particular for the turbine blade or vane 120, 130 and components of the combustion chamber 110. Superalloys of this type are known, for example, from EP 1 204 776, EP 1 306 454, EP 1 319 729, WO 99/67435 or WO 00/44949; these documents form part of the disclosure.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon and/or at least one rare earth element) and against heat by means of a thermal barrier coating. The thermal barrier coating consists, for example, of ZrO₂, Y₂O₄—ZrO₂, i.e. unstabilized, partially stabilized or fully stabilized by yttrium oxide and/or calcium oxide and/or magnesium oxide. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1.-15. (canceled)

16. A process for an electrolytic treatment of a component having at least two through-holes, comprising:
treating the through-holes on a inner surface; and
using a single pole electrode having a plurality of projections for the through-holes, wherein the through-holes have an identical polarity, and wherein the projections project into the through-holes.

17. The process as claimed in claim 16, wherein each projection projects into the respective through-hole.

18. The process as claimed in claim 17, wherein the treating of the at least two through-holes is a coating.

19. The process as claimed in claim 17, wherein during the treatment an electrolyte flows through the two through-holes.

20. The process as claimed in claim 19, wherein the electrolyte flows from an inside outward, out of a cavity.

21. The process as claimed in claim 19, wherein the component is a pole counterelectrode in an electrolytic process.

22. The process as claimed in claim 21, wherein the pole electrode is of a locally different configuration depending on the through-hole.

23. The process as claimed in claim 21, wherein the through-holes are made via an EDM electrode, and wherein the EDM electrode is used as a pole electrode for the electrolytic process.

24. The process as claimed in claim 21, wherein the pole electrode is arranged outside a hollow component.

25. The process as claimed in claim 17, wherein a time-dependent flow of an electrolyte through at least one through-hole is measured, and wherein the progress of the internal coating of the through-hole is determined based upon the flow.

26. The process as claimed in claim 17, wherein the component is arranged in an electrolyte, and wherein a further electrolyte flows through the at least two through-holes.

27. The process as claimed in claim 26, wherein the further electrolyte has a different chemical composition than a material for the coating.

28. The process as claimed in claim 17, wherein a voltage present across the component being a pole counterelectrode and the pole electrode, is pulsed.

29. The process as claimed in claim 17, wherein only a inner surface is coated.

30. The process as claimed in claim 17, wherein only a inner surface and an internal surface of the component are coated.

31. The process as claimed in claim 17, wherein only a inner surface and an external surface of the component are coated.

32. The process as claimed in claim 17, wherein a inner surface, an external surface and an internal surface of the component are coated.

33. A turbine blade of a gas turbine, comprising:
through-holes treated based upon an electrolytic treatment based upon an inner surface treatment by using a single pole electrode having projections for the through-holes, wherein the through-holes are film-cooling holes.

34. A process for the electrolytic treatment of a hollow blade of a turbomachine, comprising:
providing the blade having through-holes in a leading edge;
treating the through-holes on a inner surface based upon the electrolytic treatment; and
using a single pole electrode having projections for the through-holes, wherein the through-holes have an identical polarity and the projections have an identical polarity.

35. The process as claimed in claim 34, wherein the blade is hollow, wherein an electrolyte flows through the through-holes during the treatment, and wherein the electrolyte flows from an inside outward out of the hollow blade.
